(19) United States
(12) Patent Application Publication
(10) Pub. No.: US 2020/0396189 A1
(43) Pub. Date: Dec. 17, 2020

(54) METHOD AND APPARATUS FOR IMPROVED ELECTRONIC MAIL FILTERING USING MEDIA VIEWING HISTORY

(71) Applicant: Rovi Guides, Inc., San Jose, CA (US)

(72) Inventors: Vikram Makam Gupta, Bangalore (IN); Vijay Kumar, Bangalore (IN)

(21) Appl. No.: 16/440,866

(22) Filed: Jun. 13, 2019

(51) Int. Cl. H04L 12/58; H04L 29/08

(52) U.S. Cl. CPC H04L 51/12; H04L 67/22

(57) ABSTRACT

Systems and methods for implementing a media entertainment system that communicates with a viewer's email application, to suppress email filters for email related to content that the system determines is of interest to the viewer. The media entertainment system determines interest in a particular topic from content that it plays for the viewer. The system also estimates the degree to which the viewer is interested in this topic and determines a time period corresponding to the viewer's degree of interest. The system then instructs the viewer's email application to avoid filtering emails related to the topic, for an amount of time corresponding to the time period. In this manner, the system allows viewers to receive emails that might ordinarily be filtered, but which relate to a topic that the viewer has developed recent interest in.

### BACKGROUND

Embodiments of the disclosure relate generally to media entertainment systems. More specifically, embodiments of the disclosure relate to media entertainment systems for improving electronic mail filtering.

### SUMMARY

Contemporary electronic mail systems have become effective in enabling efficient communication. In particular, current electronic mail, or email, systems provide a convenient way for users to receive useful information from any number of senders. This capability, however, also allows for abuse. Unscrupulous advertisers can send large amounts of unwanted advertisements, or other emails, often referred to as spam, to recipients. Other more malicious entities can even send malware and other undesirable programs, infecting the computing devices of recipients who unwittingly execute such code and causing potentially significant harm.

As a result, contemporary email systems incorporate software filters that automatically scan and classify incoming emails into one of a number of categories such as spam, advertising or promotions, and the like. These filters save users the effort of laboriously inspecting and categorizing every incoming email themselves, and as such can provide significant benefit to users. Such filtering systems are not without their drawbacks, however. Particularly, they are often overly restrictive, categorizing some emails as spam or as some other detrimental category when they are not. This leads to users sometimes failing to see or read important or beneficial emails.

As an example, users may view a movie or read an article that spurs an interest in a particular topic. For instance, seeing or reading about a particularly attractive travel destination may spark the user's interest in potentially visiting that destination. Contemporary computer-based software may detect this interest and automatically send the user email containing information and advertisements related to this destination. While email filters would typically classify these emails as spam, in this case the user is interested in the destination and may actually wish to receive and read the email. The filter thus suffers from inadequate resolution, unable to distinguish situations in which the user is actually interested in receiving emails on certain topics that would ordinarily be considered undesirable.

Accordingly, to overcome the problems and limitations of overly restrictive email filters, systems and methods are described herein for a computer-based process that detects user interest in a particular topic and instructs email applications to suppress their filters on that topic for a period of time. Continuing the above example, a system may detect a user visiting sites and reading articles on Thailand. The system then instructs the user's email application to suppress its filter for the keyword “Thailand”, for some amount of time. This allows the user to receive, for instance, advertisements for travel deals to Thailand which the user may be interested in.

To carry out this process, a media entertainment system may examine the content it generates for display to a user, and determine keywords characterizing that content. The system also specifies a period of time for this keyword, where the period of time is the amount of time that the email filter is suppressed for that keyword. Once the keyword and period of time are determined, the system transmits them to the email application, directing the application to disregard the keyword for the period of time. Email filtering is thus disabled for an amount of time that the user is estimated to be interested in emails concerning the determined keyword, increasing the likelihood that the user will see these emails.

The above described process can be applied to any type of email filter. While spam filters are a well-known type of email filter, other types of filters exist as well, and the systems and processes of the disclosure can be applied to any such filters. Examples include advertising and promotion filters, filters that designate emails as starred or important, and any other filter that categorizes emails as belonging in either an inbox or another email bin.

The systems of the disclosure also include feedback mechanisms for continually improving the accuracy of their filter suppression. In one embodiment, email applications can return an indicator when the user or the application categorizes an email containing the keyword as spam or as another category. This informs the media entertainment system that the user does not wish to receive at least some emails containing this keyword, i.e., at least some emails containing this keyword are still considered to belong to a category such as spam. In response, the media entertainment system can adjust its instructions, to allow the email filter to be more restrictive. For example, the system can reduce the time period associated with that keyword, so that email containing that keyword is allowed to pass through the filter for a shorter amount of time. Receiving a sufficient number of such indicators may represent that the user is classifying every, or many, emails containing that keyword as spam, indicating that he or she does not wish to receive any more emails containing the keyword. This can prompt the system to halt its instructions and allow email filters to resume filtering based on the keyword.

Keywords may be determined in any manner. As one example, keywords can be determined from metadata of the content currently being displayed to the viewer. Such metadata often includes several terms characterizing its associated content, such as the genres of the content, main actors or actresses, locations or cities in which the content primarily takes place, and the like. Many of these terms can indicate interest in the subject matter of the keyword. A viewer that watches many travel shows about a particular destination, for example, may likely be interested in traveling to that destination. Similarly, watching several concerts from a particular artist may indicate strong interest in that artist, or a desire to see an upcoming concert or performance by that artist. These keywords can thus be extracted from metadata to serve as instructions to email applications, allowing the viewer to see emails containing those keywords.

Keywords and the frequency with which they appear may indicate the degree of user interest in content subject matter. In the example of a viewer watching shows about a particular travel destination, the amount of time that the user spends watching such shows may correlate to his or her degree of interest in that destination. A user who spends a large amount of time viewing a particular destination is likely more interested in that destination than a viewer who spends very little time watching shows about that destination, and likely would be receptive to emails about that destination for a longer period of time. The media entertainment system of the disclosure can thus specify this period of time according to the screen time of content having a particular keyword. That is, the period of time for which the email filter is instructed to disregard a keyword can be based at least in part on the total screen time of content having that keyword.

The time period can also be based on other factors besides, or in addition to, screen time. For example, the time period can be based on the length of time the viewer pauses content concerning a particular keyword. When the media entertainment system includes a remote controller with a “like” button or allows a user to enter a like indication in another manner such as a visual like button on a graphical interface, the time period can also be based on the number of likes entered. The time period may be based on any combination of these or other factors, in any manner.

This time period may also be determined according to one or more predetermined thresholds. In particular, in some embodiments of the disclosure, any of the above factors may influence the calculated time period if they exceed predetermined thresholds. For instance, once the total screen time of content having a particular keyword exceeds some threshold, it may be used as a factor in determining the time period for which the email filter is instructed to disregard the keyword. Similarly, pause lengths that exceed some threshold may influence the time period, as may likes once they exceed some threshold number.

### BRIEF DESCRIPTION OF THE FIGURES

The above and other objects and advantages of the disclosure will be apparent upon consideration of the following detailed description, taken in conjunction with the accompanying drawings, in which like reference characters refer to like parts throughout, and in which:

FIG. 1 illustrates an exemplary process of detecting viewer interest in a topic and instructing email applications to suppress their filters for that topic, in accordance with embodiments of the disclosure;

FIG. 2 shows an illustrative embodiment of a display screen that may be used to provide media guidance application listings and other media guidance information, in accordance with some embodiments of the disclosure;

FIG. 3 shows another illustrative embodiment of a display screen that may be used to provide media guidance application listings, in accordance with some embodiments of the disclosure;

FIG. 4 is a block diagram of an illustrative user equipment (UE) device in accordance with some embodiments of the disclosure;

FIG. 5 is a block diagram of an illustrative media system in accordance with some embodiments of the disclosure;

FIG. 6 is a flowchart illustrating process steps for modifying electronic mail filter criteria from a media entertainment system;

FIG. 7 is a table of keywords and the factors used in determining time periods that email filters are suppressed for those keywords; and

FIG. 8 illustrates tabulated factors for each keyword of FIG. 7.

### DETAILED DESCRIPTION

In one embodiment, the disclosure relates to systems and methods for implementing a media entertainment system that communicates with a viewer's email application, to suppress email filters for email related to content that the system determines is of interest to the viewer. The media entertainment system determines interest in a particular topic from content that it plays for the viewer. The system also estimates the degree to which the viewer is interested in this topic and determines a time period corresponding to the viewer's degree of interest. The system then instructs the viewer's email application to avoid filtering emails related to the topic, for an amount of time corresponding to the time period. In this manner, the system allows viewers to receive emails that might ordinarily be filtered, but which relate to a topic that the viewer has developed recent interest in.

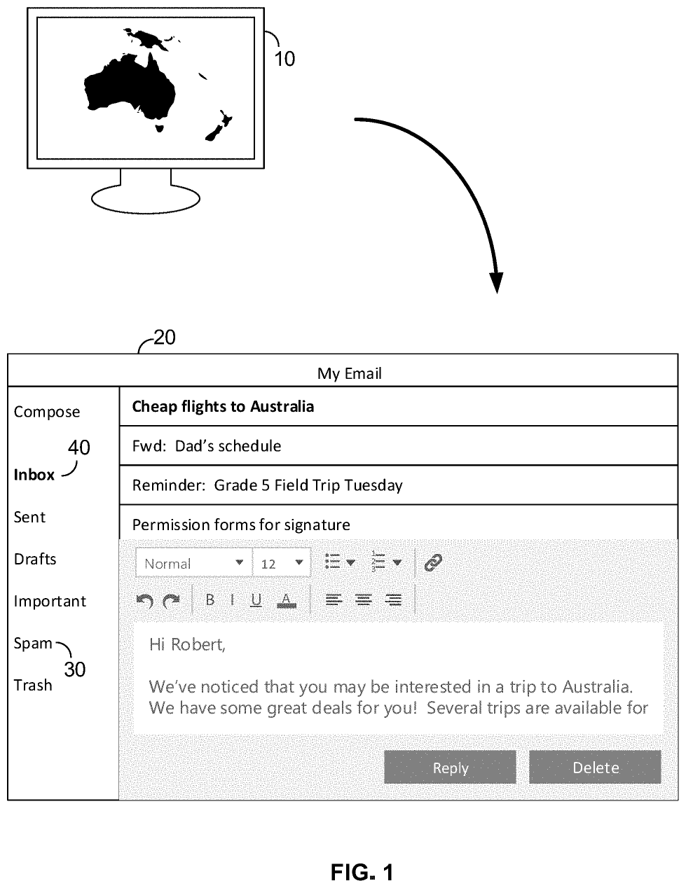

FIG. 1 graphically illustrates an exemplary process of detecting viewer interest in a topic and instructing email applications to suppress their filters for that topic, in accordance with embodiments of the disclosure. Here, a media entertainment system provides an interface for selecting and playing programs on a display 10, where a viewer has selected electronic content to watch. In this example, the viewer has selected a program concerning Australia, such as an episode of a travel show that documents a trip to Australia, a cooking program showcasing Australian chefs, or the like. If the viewer demonstrates interest in Australia, such as by watching a number of such shows or pausing the current show several times, the media entertainment system notes the viewer's interest in the subject. In particular, the system selects the keyword “Australia” from the content and determines a time period whose length corresponds to the viewer's perceived interest in the keyword. Greater interest, as evidenced by factors such as the amount of time spent watching content on that subject, the amount of time the viewer pauses content on that subject, or perhaps the number of likes entered by the viewer, indicates greater interest and thus a longer time period.

The media entertainment system transmits the keyword “Australia” along with its corresponding calculated time period, to the viewer's email application 20, directing the application 20 to suspend filtering on the term “Australia” for an amount of time equal to the calculated time period. Various automated systems related or unrelated to the systems of this disclosure may send the viewer email based on his or her apparent interest in Australia. An example of this can be seen in FIG. 1, where the viewer receives an email offer of cheap flights to Australia. Such an email would ordinarily be classified as spam by the automatic filtering software of email application 20, and would be automatically placed in the Spam folder 30 without the viewer seeing it in his or her Inbox 40. However, because the media entertainment system has instructed the automatic filtering software to suspend any filtering it might perform based on the keyword “Australia”, the email is placed in the Inbox 40 instead of the Spam folder 30. In this manner the viewer, who has demonstrated an interest in Australia, is more likely to receive and view emails that he or she is interested in, rather than having them misclassified as spam or some other undesirable category.

The media entertainment system may be any system capable of determining content viewed by a user and transmitting instructions to the user's email application. In one embodiment, the media entertainment system is a system that displays content to viewers via an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

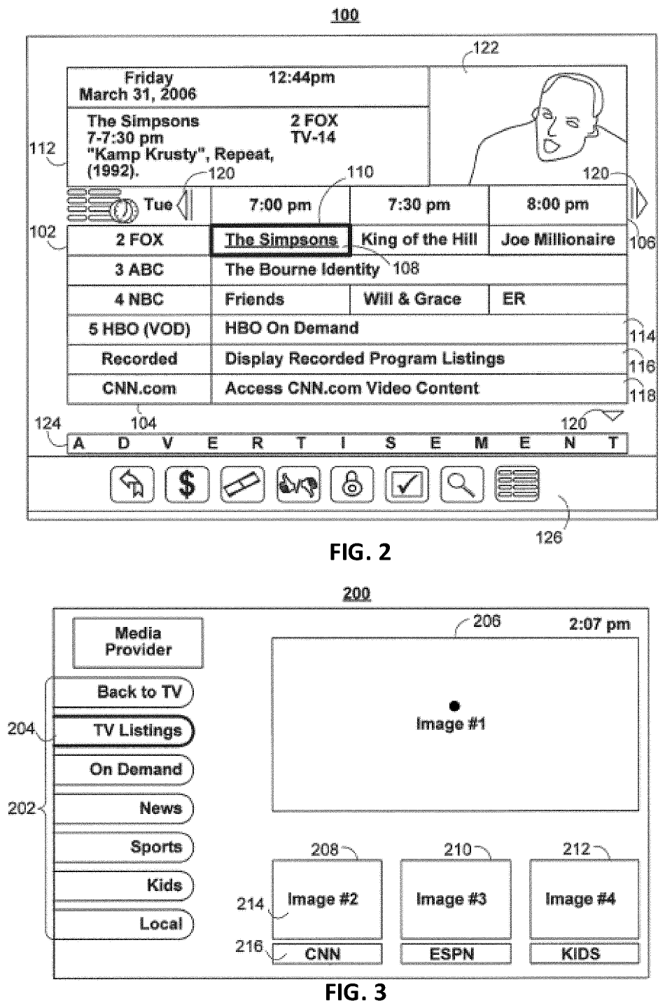

FIGS. 2-3 show illustrative user interface screens of an interactive media guidance application capable of carrying out the processes of the disclosure. The display screens shown in FIGS. 2-3 may be implemented on any suitable user equipment device or platform. While the displays of FIGS. 2-3 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 2 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies, or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g., FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases. While advertisement 124 is shown as rectangular or banner shaped, advertisements may be provided in any suitable size, shape, and location in a guidance application display.

Options region 126 may allow the user to access different types of content, media guidance application displays, and/or media guidance application features. Options region 126 may be part of display 100 (and other display screens described herein) or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

Another display arrangement for providing media guidance is shown in FIG. 3. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

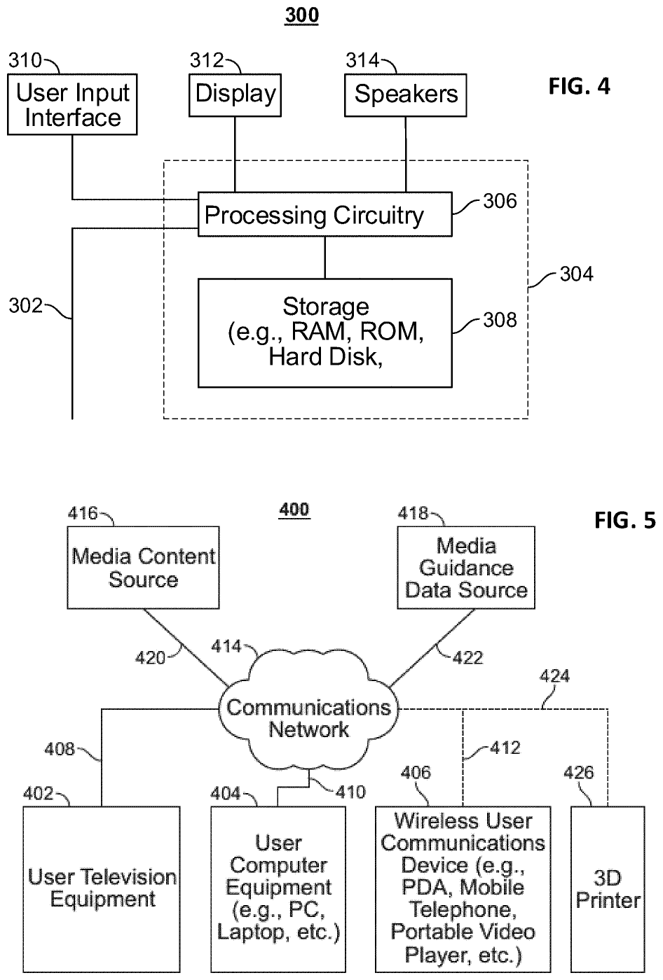

Users may access content and the media guidance application (and its display screens described above and below) from one or more of their user equipment devices. FIG. 4 shows a generalized embodiment of illustrative user equipment device 300. More specific implementations of user equipment devices are discussed below in connection with FIG. 5. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 5 as user television equipment 402, user computer equipment 404, wireless user communications device 406, 3D printer 426, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below. Various methods and systems for utilizing 3D printers are discussed in, for example, Abeloe, U.S. Pat. No. 8,243,334, filed Jun. 5, 2009, Lai et al., U.S. Patent Publication No. 2008/0260918, filed Apr. 23, 2007, and Jandeska, Jr. et al., U.S. Pat. No. 7,141,207, filed Aug. 30, 2004, which are hereby incorporated by reference herein in their entireties.

A user equipment device utilizing at least some of the system features described above in connection with FIG. 3 may not be classified solely as user television equipment 402, user computer equipment 404, a wireless user communications device 406, or 3D printer 426. 3D printer 426 may be used to achieve the objects of the description above and below. User television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 5 to avoid overcomplicating the drawing. In addition, each user may utilize more than one type of user equipment device and also more than one of each type of user equipment device.

The user equipment devices may be coupled to communications network 414. Namely, user television equipment 402, user computer equipment 404, and wireless user communications device 406, and 3D printer 426 are coupled to communications network 414 via communications paths 408, 410, 412, and 424, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, 412, and 424 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408, 410, and 424 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, 412, and 424 as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, 412 and 424. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, 406, and 426 are shown as through communications network 414, in some embodiments, sources 416 and 418 may communicate directly with user equipment devices 402, 404, 406, and 426 via communication paths (not shown) such as those described above in connection with paths 408, 410, 412, and 426.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition, or in the alternative, the remote computing sites may include other user equipment devices, such as user television equipment 402, user computer equipment 404, wireless user communications device 406, and 3D printer 426. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

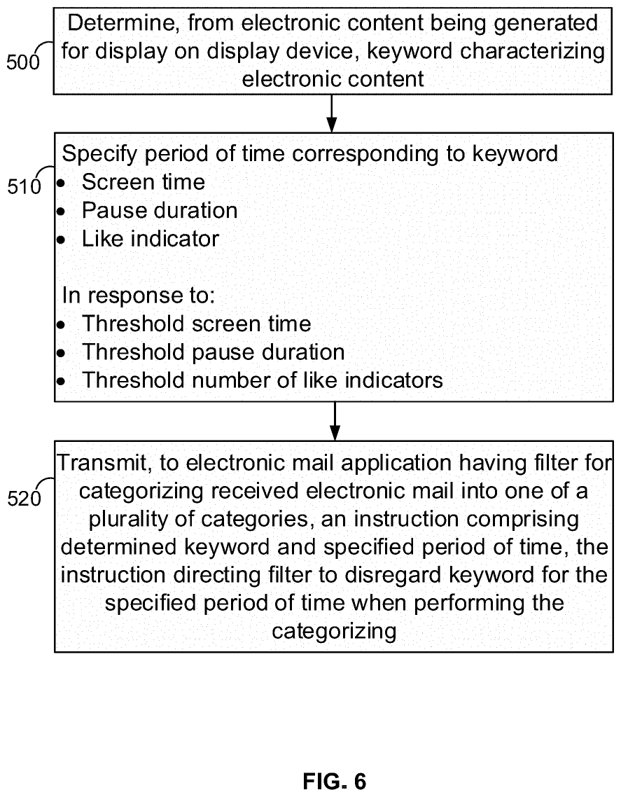

FIG. 6 is a flowchart illustrating process steps for modifying electronic mail filter criteria from a media entertainment system. First, a media guidance application such as that described above determines, from electronic content being generated for display on a display device, a keyword characterizing the electronic content (Step 500). More specifically, a viewer may select content from program listings display 100, whereupon media content source 416 transmits both the selected content and associated metadata to the media guidance application. The application generates the content for display on display 312, and reads keywords characterizing the content from the metadata. The keywords may be any words contained in the metadata that characterize the content. For instance, metadata may contain information on the content such as its applicable genre or genres, actor names, director names, prominent subject matter of the content such as locations or events shown, people or subjects discussed therein, and the like. Any one or more of these may be selected as keywords.

The media guidance application then specifies a period of time corresponding to the keyword (Step 510). This period of time is the amount of time that the viewer's email application is to ignore the keyword or keywords when filtering email. The period of time may be determined in any manner, but in one embodiment the period of time is determined according to factors that can include screen time of the portions of content corresponding to the selected keywords, the duration for which content is paused at a point at which subject matter of the keywords are shown, and selections of a like indicator on a remote control or other user input interface 10, or displayed for selection from the media guidance application.

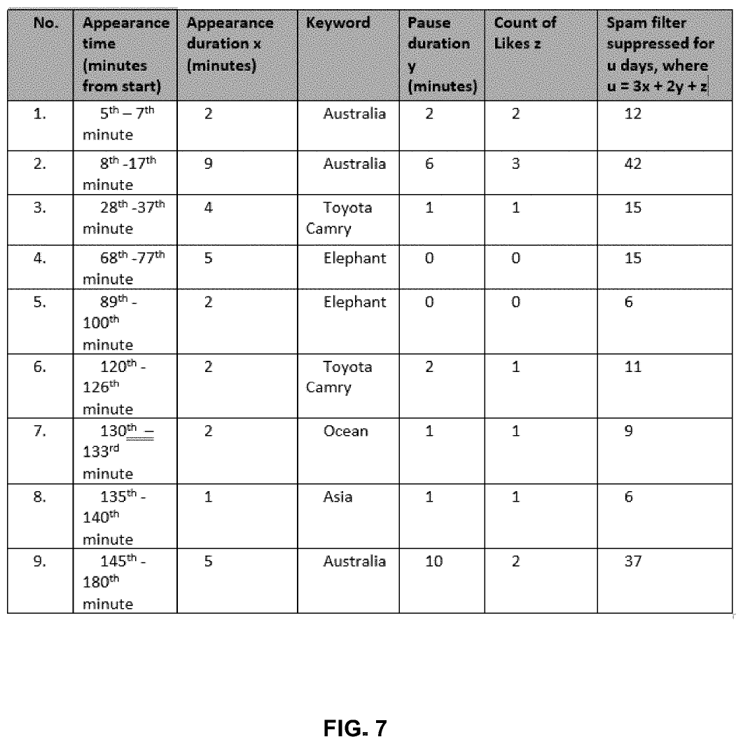

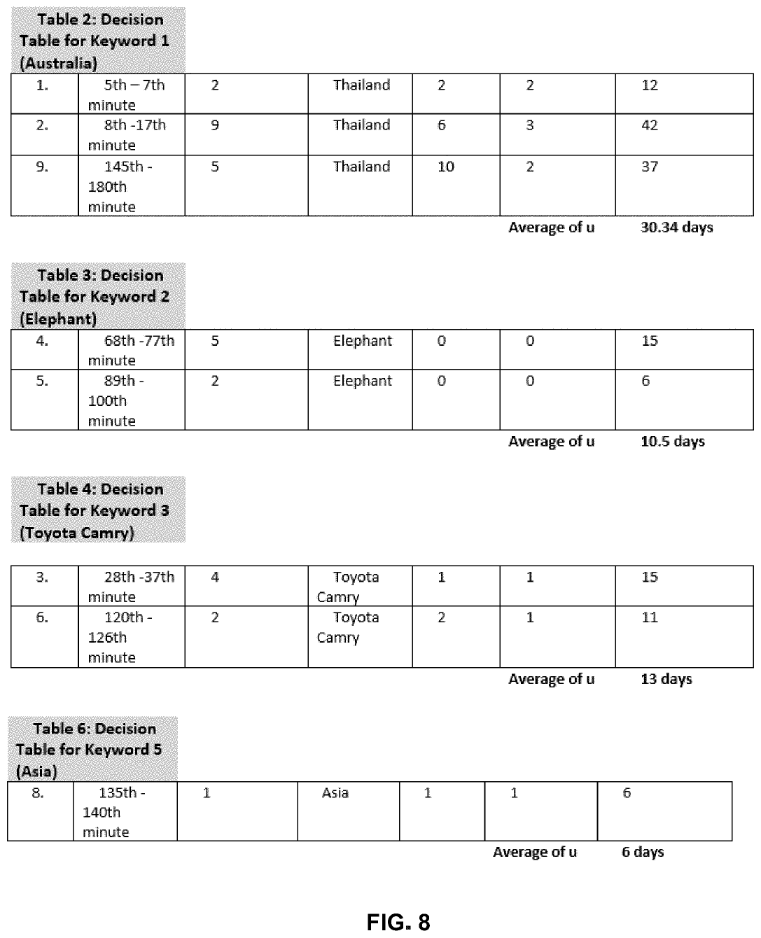

Further details on the period of time, its calculation, and factors contributing to its determination are described below in connection with FIGS. 7 and 8. FIG. 7 is a table of keywords and the factors used in determining time periods that email filters are suppressed for those keywords, and FIG. 8 illustrates tabulated factors for each keyword of FIG. 7. These Figures tabulate exemplary keywords that appear in content being played, the amount of time content corresponding to these keywords is played, the duration that content corresponding to these keywords is paused, and the number of likes entered by the user during play of content corresponding to the keywords. Email filter suppression is determined from each of these factors. More specifically, the amount of time u that the guidance application instructs an email application to suppress filtering of a particular keyword is determined in this embodiment according to:

u=3x+2y+z (1)

As seen in FIGS. 7 and 8, u is the amount of time in days that the guidance application instructs an email application to suppress filtering of a particular keyword, x is the duration in minutes that content corresponding to the particular keyword is displayed, y is the pause duration in minutes for which content corresponding to the particular keyword is paused, and z is the integer number of likes entered by the viewer during play of content corresponding to the particular keyword. It is noted that embodiments of the disclosure contemplate determination of the amount of time that the guidance application instructs an email application to suppress filtering of a particular keyword, and this amount of time may be determined in any manner, whether by equation (1) or otherwise. That is, this amount of time can be determined by any relationship between or among any factors, whether by a different relationship between factors x, y, and z, or by a relationship involving other factors entirely.

In operation, the media guidance application retrieves keywords of content being played, from metadata of that content as above. The keywords are logged as in the tables of FIGS. 7 and 8, and the appearance duration of corresponding content, pause duration during these appearance durations, and likes during these appearances are recorded and tabulated. The duration u is then determined according to equation (1) or another relationship, whereupon the keyword and its corresponding duration u are transmitted by the media guidance application to the viewer's email application as an instruction to suppress filtering based on that particular keyword for u days.

The durations u for tabulated keywords may be averaged, with the average u value being the value transmitted to the viewer's email application. Thus, in the example of FIGS. 7 and 8, they keyword “Australia” may appear three times for a particular user's content, with an average corresponding u value of 30.34 days. The media guidance application this transmits an instruction to that viewer's email application, directing the application to disregard the term “Australia” in filtering for 30.34 days (perhaps rounded to the nearest integer day). This process may be repeated for other keywords, with the media guidance application instructing the viewer's email application on various keywords at any time. For instance, during the above 30.34 day period, the viewer's email application may also be instructed to disregard the term “elephant” in filtering for 10.5 days, and to disregard the term “Toyota Camry” for 13 days. If the term “Asia” does not meet the above mentioned threshold, the media guidance application may not instruct the email application on this term.

The media guidance application may determine whether to record a keyword in the tables of FIGS. 7 and 8, in any manner. For example, the application may simply retrieve and log keywords for all content a viewer plays. Alternatively, the application may only log keywords after a predetermined number of appearances, pauses, or likes. Additionally, the media guidance application may determine whether or not to send keywords in any manner. For instance, the media guidance application may send, to the email application, every keyword it logs in its tables. Alternatively, as this may result in too many keywords exempted from filtering, the media guidance application may only send keywords after a predetermined number of appearances, pauses, or likes. Embodiments of the disclosure contemplate any method of determining whether to record a keyword, and whether to send a keyword to an email application.

As previously described, embodiments of the disclosure also include feedback mechanisms for continually improving the accuracy of their filter suppression. In one embodiment, email applications can be programmed to return an indicator when the user or the application categorizes an email containing the keyword as spam or as another category. That is, while the media guidance application may instruct an email application not to filter certain emails, the user may nevertheless view these emails as undesirable anyway. The user may thus manually categorize an email as spam for instance, after the filter allowed the email through. The email application may inform the media guidance application of this, which informs the media guidance application that the user considers at least some emails containing this keyword to belong to a category such as spam.

In response, the media guidance application can adjust its instructions, to allow the email filter to be more restrictive. For example, the system can reduce the time period associated with that keyword, so that email containing that keyword is allowed to pass through the filter for a shorter amount of time. Receiving a sufficient number of such indicators may represent that the user is classifying every, or many, emails containing that keyword as spam, indicating that he or she does not wish to receive any more emails containing the keyword. In response, the media guidance application may halt its instructions and allow email filters to resume filtering based on the keyword. Embodiments of the disclosure contemplate modification of these time periods in any manner and by any amount, based on any number of indications of user-classified emails.

The foregoing description, for purposes of explanation, used specific nomenclature to provide a thorough understanding of the disclosure. However, it will be apparent to one skilled in the art that the specific details are not required to practice the methods and systems of the disclosure. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, a media guidance application may determine keywords in any manner, and instruct email applications to disregard these keywords for filtering purposes, for any duration. This duration may be determined in any manner, by any relationship between or among any factors. The embodiments were chosen and described in order to best explain the principles of the invention and its practical applications, to thereby enable others skilled in the art to best utilize the methods and systems of the disclosure and various embodiments with various modifications as are suited to the particular use contemplated. Additionally, different features of the various embodiments, disclosed or otherwise, can be mixed and matched or otherwise combined so as to create further embodiments contemplated by the disclosure.

1. A method of modifying electronic mail filter criteria from a media entertainment system, the method comprising:
determining, from electronic content being generated for display on a display device, a keyword characterizing the electronic content;
specifying a period of time as a factor of a screen time during which a portion of the electronic content characterized by the keyword is generated for display; and
transmitting, to an electronic mail application having a filter for categorizing received electronic mail into one of a plurality of categories, an instruction comprising the determined keyword and the specified period of time as a factor of a screen time, the instruction directing the filter to disregard the keyword for the specified period of time when performing the categorizing.

2. The method of claim 1, wherein the plurality of categories includes an inbox category and a spam category.

3. The method of claim 2 further comprising receiving, after the transmitting and from the electronic mail application, an indication that the received electronic mail was categorized as spam.

4. The method of claim 3 further comprising, in response to receiving the indication, reducing the specified period of time.

5. The method of claim 1, wherein the determining further comprises retrieving the keyword from metadata of the electronic content being generated for display.

6. (canceled)

7. The method of claim 1, wherein the specifying further comprises specifying the period of time according to a pause duration during which the portion of the electronic content characterized by the keyword is paused.

8. The method of claim 1, wherein the specifying further comprises specifying the period of time according to a like indicator corresponding to interest in a subject matter of the keyword.

9. The method of claim 8, further comprising receiving the like indicator from a remote controller of the media entertainment system.

10. The method of claim 1, wherein the specifying is performed in response to detecting a threshold screen time during which a portion of the electronic content characterized by the keyword is generated for display for at least a predetermined threshold of time, a threshold pause duration during which the portion of the electronic content characterized by the keyword is paused for at least a predetermined time period, or a threshold number of like indicators each corresponding to interest in a subject matter of the keyword.

11. A system for modifying electronic mail filter criteria from a media entertainment system, the system comprising:
a storage device; and
control circuitry configured to:
determine, from electronic content being generated for display on a display device, a keyword characterizing the electronic content;
specify a period of time as a factor of a screen time during which a portion of the electronic content characterized by the keyword is generated for display; and
transmit, to an electronic mail application having a filter for categorizing received electronic mail into one of a plurality of categories, an instruction comprising the determined keyword and the specified period of time, the instruction directing the filter to disregard the keyword for the specified period of time as a factor of a screen time, when performing the categorizing.

12. The system of claim 11, wherein the plurality of categories includes an inbox category and a spam category.

13. The system of claim 12 wherein the control circuitry is further configured to receive, after the transmitting and from the electronic mail application, an indication that the received electronic mail was categorized as spam.

14. The system of claim 13 wherein the control circuitry is further configured to, in response to receiving the indication, reduce the specified period of time.

15. The system of claim 11, wherein the determining further comprises retrieving the keyword from metadata of the electronic content being generated for display.

16. (canceled)

17. The system of claim 11, wherein the specifying further comprises specifying the period of time according to a pause duration during which the portion of the electronic content characterized by the keyword is paused.

18. The system of claim 11, wherein the specifying further comprises specifying the period of time according to a like indicator corresponding to interest in a subject matter of the keyword.

19. The system of claim 18, wherein the control circuitry is further configured to receive the like indicator from a remote controller of the media entertainment system.

20. The system of claim 11, wherein the specifying is performed in response to detecting a threshold screen time during which a portion of the electronic content characterized by the keyword is generated for display for at least a predetermined threshold of time, a threshold pause duration during which the portion of the electronic content characterized by the keyword is paused for at least a predetermined time period, or a threshold number of like indicators each corresponding to interest in a subject matter of the keyword. 21-30. (canceled)
